(19) United States
(12) Patent Application Publication
(10) Pub. No.: US 2026/0142460 A1
(43) Pub. Date: May 21, 2026

(54) Electric Power Transmission Safety Monitoring System for Thunderstorm Area

(71) Applicant: Guizhou Power Grid Co., Ltd., Guiyang (CN)

(72) Inventors: Qianyong LV, Guiyang (CN); Guangze OUYANG, Guiyang (CN); Lei FU, Guiyang (CN); Qiansu LV, Guiyang (CN); Zhukui TAN, Guiyang (CN); Xun ZHANG, Guiyang (CN); Xianyin MAO, Guiyang (CN); Huan HUANG, Guiyang (CN); Peilong CHEN, Guiyang (CN); Qi YANG, Guiyang (CN); Mian WANG, Guiyang (CN); Yu SHEN, Guiyang (CN); Yong GAO, Guiyang (CN); Xianwu ZENG, Guiyang (CN); Yu WU, Guiyang (CN); Diao ZOU, Guiyang (CN); Yizhao ZHANG, Guiyang (CN); Xiaodong REN, Guiyang (CN); Wei NIU, Guiyang (CN); Shouchang WU, Guiyang (CN); Rongjun HU, Guiyang (CN); Jianrong WU, Guiyang (CN); Qili ZHANG, Guiyang (CN); Zhiming DING, Guiyang (CN); Qixue ZHU, Guiyang (CN); Shuang RAN, Guiyang (CN); Qiu YANG, Guiyang (CN); Canyu LIU, Guiyang (CN); Hao LIU, Guiyang (CN); Le CHEN, Guiyang (CN); Jufu GUO, Guiyang (CN); Keyu CHEN, Guiyang (CN); Wei ZHANG, Guiyang (CN)

(21) Appl. No.: 19/445,592

(22) Filed: Jan. 11, 2026

Related U.S. Application Data
(63) Continuation of application No. PCT/CN2024/134034, filed on Nov. 23, 2024.

(30) Foreign Application Priority Data
Nov. 23, 2023 (CN) 202311582013.X

(51) Int. Cl. H02J 3/001; G01W 1/10; H02J 103/35

(52) U.S. Cl. CPC H02J 3/00125; G01W 1/10; G01W 2203/00; H02J 2103/35

(57) ABSTRACT

The disclosure provides an electric power transmission safety monitoring system for a thunderstorm area. The system includes a transmission platform, an area characteristic analysis unit and a transmission influence analysis unit, where the transmission platform may receive an electric power transmission request sent by a current power supply end, determine a power demand end and a transmission area where the power demand end is located. After receiving the area characteristic analysis signal sent by the transmission platform, the area characteristic analysis unit carries out thunderstorm characteristic analysis, and sends the analysis result to the transmission influence analysis unit and the transmission platform. The transmission platform further formulates an electric power transmission strategy.

### CROSS-REFERENCE TO RELATED APPLICATIONS

The present application is a continuation of International Application No. PCT/CN2024/134034, filed on Nov. 23, 2024, which claims priority to Chinese Patent Application No. 202311582013.X, filed on Nov. 23, 2023, the entire disclosure of which is incorporated herein by reference.

### TECHNICAL FIELD

The disclosure relates to the technical field of electric power transmission safety monitoring, in particular to an electric power transmission safety monitoring system for a thunderstorm area.

### BACKGROUND

A thunderstorm is local convective weather accompanied by thunderstrike and lightning, is a discharge phenomenon in the atmosphere, is generally accompanied by a shower, and sometimes may be strong convective weather such as local strong wind and hail. Disasters may be caused sometimes when strong thunderstorm weather occurs, for example, thunderstrike endangers personal safety, household appliances and computer rooms are damaged directly by influences of thunderstrike or inductive thunder, and sometimes a fire is caused.

In the relevant art, thunderstorm weather characteristic analysis cannot be carried out on a transmission area during electric power transmission, and then electric power transmission dispatching cannot be carried out according to area characteristics, so that the stability and safety of electric power transmission are influenced.

### SUMMARY

The disclosure aims to overcome at least one of the above technical defects, in particular the technical defect that in the relevant art, thunderstorm weather characteristic analysis cannot be carried out on a transmission area during electric power transmission, and then electric power transmission dispatching cannot be carried out according to area characteristics, so that the stability and safety of electric power transmission are influenced.

The disclosure provides an electric power transmission safety monitoring system for a thunderstorm area. The system includes a transmission platform, an area characteristic analysis unit and a transmission influence analysis unit.

The transmission platform is configured to receive an electric power transmission request sent by a current power supply end, determine a power demand end and a transmission area where the power demand end is located according to the electric power transmission request, and then send an area characteristic analysis signal of the transmission area to the area characteristic analysis unit.
the area characteristic analysis unit is configured to receive the area characteristic analysis signal, carry out thunderstorm characteristic analysis on the transmission area according to the area characteristic analysis signal, and send the thunderstorm characteristic analysis result to the transmission influence analysis unit and the transmission platform;
the transmission platform is further configured to receive the thunderstorm characteristic analysis result, formulate an electric power transmission strategy of the transmission area according to the thunderstorm characteristic analysis result, and send a transmission influence analysis signal to the transmission influence analysis unit in the process that electric power of the current power supply end is transmitted to the power demand end according to the electric power transmission strategy;
the transmission influence analysis unit is configured to receive the transmission influence analysis signal and the thunderstorm characteristic analysis result, carry out thunderstorm influence analysis on thunderstorm influence situation of the real-time electric power transmission process of the transmission platform according to the transmission influence analysis signal and the thunderstorm characteristic analysis result, and send the thunderstorm influence analysis result to the transmission platform, so that the transmission platform determines whether to adjust the electric power transmission strategy or not.

Optionally, the process that the area characteristic analysis unit carries out thunderstorm characteristic analysis on the transmission area according to the area characteristic analysis signal to obtain a thunderstorm characteristic analysis result includes:
determining, by the area characteristic analysis unit, an area in which thunderstorm exists in the transmission area according to the area characteristic analysis signal, and after marking the area in which thunderstorm exists as a thunderstorm analysis area, acquiring instantaneous increase amount corresponding to cloud-to-ground lightning frequency of the thunderstorm in the thunderstorm analysis area, average probability of lightning current amplitude of each area in the thunderstorm analysis area, and average duration period of thunderstorm weather occurring in the thunderstorm analysis area;
generating, by the area characteristic analysis unit, a thunderstorm characteristic analysis coefficient in the thunderstorm analysis area according to the instantaneous increase amount, average probability of lightning current amplitude of each area and average duration period of thunderstorm weather occurring in the thunderstorm analysis area, and determining a thunderstorm characteristic analysis result of the thunderstorm analysis area according to the thunderstorm characteristic analysis coefficient.

Optionally, in generating, by the area characteristic analysis unit, a thunderstorm characteristic analysis coefficient in the thunderstorm analysis area according to the instantaneous increase amount, average probability of lightning current amplitude of each area and average duration period of thunderstorm weather occurring in the thunderstorm analysis area, a calculation formula is:

$$G = DS \times v 1 + GL \times v 2 + CZ \times v 3$$

In the formula, G is the thunderstorm characteristic analysis coefficient in the thunderstorm analysis area, DS is instantaneous increase amount corresponding to cloud-to-ground lightning frequency of the thunderstorm in the thunderstorm analysis area, GL is average probability of lightning current amplitude of each area in the thunderstorm analysis area, CZ is average duration period of thunderstorm weather occurring in the thunderstorm analysis area, v1, v2 and v3 are preset proportional coefficients, and v1>v2>v3>0.

Optionally, the process that the area characteristic analysis unit determines a thunderstorm characteristic analysis result of the thunderstorm analysis area according to the thunderstorm characteristic analysis coefficient includes:
comparing, by the area characteristic analysis unit, the thunderstorm characteristic analysis coefficient with a preset thunderstorm characteristic analysis coefficient threshold;
when determining the thunderstorm characteristic analysis coefficient exceeds the thunderstorm characteristic analysis coefficient threshold, judging, by the area characteristic analysis unit, the thunderstorm characteristics in the thunderstorm analysis area as high influence characteristics; and
when determining the thunderstorm characteristic analysis coefficient does not exceed the thunderstorm characteristic analysis coefficient threshold, judging, by the area characteristic analysis unit, the thunderstorm characteristics in the thunderstorm analysis area as low influence characteristics.

Optionally, the thunderstorm characteristic analysis result includes a thunderstorm analysis area with high influence characteristics and a thunderstorm analysis area with low influence characteristics, and the thunderstorm analysis area is an area in which thunderstorm exists in the transmission area.

The process that the transmission platform formulates an electric power transmission strategy of the transmission area according to the thunderstorm characteristic analysis result includes:
when the thunderstorm characteristic analysis result is determined as the thunderstorm analysis area with high influence characteristics, carrying out thunderstorm predication, by the transmission platform, on the thunderstorm analysis area with high influence characteristics, and after determining a thunderstorm predication time period according to the thunderstorm predication result, reducing electric power transmission amount in the thunderstorm predication time period to a minimum value; and
when the thunderstorm characteristic analysis result is determined as the thunderstorm analysis area with low influence characteristics, determining, by the transmission platform, whether electric power transmission amount, in the thunderstorm predication time period, of the thunderstorm analysis area with high influence characteristics in the transmission area is reduced to a minimum value or not, and when the electric power transmission amount cannot be reduced to the minimum value, temporarily switching an electric power transmission line of the thunderstorm analysis area with high influence characteristics to the thunderstorm analysis area with low influence characteristics.

Optionally, the thunderstorm characteristic analysis result includes a thunderstorm analysis area in which thunderstorm exists in the transmission area.

The process that the transmission influence analysis unit carries out thunderstorm influence analysis on thunderstorm influence situation of the real-time electric power transmission process of the transmission platform according to the transmission influence analysis signal and the thunderstorm characteristic analysis result to obtain a thunderstorm influence analysis result includes:
determining, by the transmission influence analysis unit, tripping frequency of a switching device in the thunderstorm analysis area during the real-time power transmission process and continuous increase span of starting height of the cloud-to-ground lightning in the thunderstorm analysis area according to the transmission influence analysis signal and the thunderstorm characteristic analysis result, and determining an electric power transmission influence result influenced by thunderstorm of the real-time electric power transmission process in the thunderstorm analysis area according to the tripping frequency of the switching device and the continuous increase span of starting height of the cloud-to-ground lightning.

Optionally, the process that determining, by the transmission influence analysis unit, the electric power transmission influence result influenced by thunderstorm of the real-time electric power transmission process in the thunderstorm analysis area according to tripping frequency of the switching device and the continuous increase span of starting height of the cloud-to-ground lightning includes:
comparing, by the transmission influence analysis unit, the tripping frequency of the switching device with a preset tripping frequency threshold, and comparing continuous increase span of starting height of the cloud-to-ground lightning with a preset a height increase span threshold;
when the tripping frequency of the switching device is determined to exceed a tripping frequency threshold or the continuous increase span of starting height of the cloud-to-ground lightning is determined to exceed a height increase span threshold, determining, by the transmission influence analysis unit, that the electric power transmission influence result influenced by thunderstorm of the real-time electric power transmission process in the thunderstorm analysis area as being influenced;
when the tripping frequency of the switching device is determined to not exceed a tripping frequency threshold and the continuous increase span of starting height of the cloud-to-ground lightning is determined to not exceed a height increase span threshold, determining, by the transmission influence analysis unit, that the electric power transmission influence result influenced by thunderstorm of the real-time electric power transmission process in the thunderstorm analysis area as not being influenced.

Optionally, the thunderstorm influence analysis result includes that real-time electric power transmission in the thunderstorm analysis area is influenced by thunderstorm and not influenced by thunderstorm, and the thunderstorm analysis area is an area in which thunderstorm exists in the transmission area.

The process that the transmission platform determines whether to adjust the electric power transmission strategy or not according to the thunderstorm influence analysis result includes:
when determining that the real-time electric power transmission process in the thunderstorm analysis area is influenced by thunderstorm, adjusting, by the transmission platform, electric power transmission amount and transmission time related to the thunderstorm analysis area in the electric power transmission strategy; and
when determining, by the transmission platform, that the real-time electric power transmission process in the thunderstorm analysis area is not influenced by thunderstorm, the electric power transmission strategy does not need to be adjusted.

Optionally, the system further includes an early warning unit.

The transmission platform is further configured to send a monitoring and early warning signal related to the electric power transmission strategy to the early warning unit after receiving a transmission influence analysis completion instruction sent by the transmission influence analysis unit.

The early warning unit is configured to receive the monitoring and early warning signal, and carry out safety monitoring and early warning on the process that the transmission platform carries out real-time electric power transmission on the power demand end according to the electric power transmission strategy, according to the monitoring and early warning signal, and send the monitoring and early warning result to the transmission platform, so that the transmission platform determines whether to adjust the electric power transmission strategy or not.

Optionally, the electric power transmission strategy includes that electric power transmission amount, in the thunderstorm predication time period, of the thunderstorm analysis area with high influence characteristics is reduced to a minimum value, and the thunderstorm analysis area is an area in which thunderstorm exists in the transmission area.

The process that the early warning unit carries out safety monitoring and early warning on the process that the transmission platform carries out real-time electric power transmission on the power demand end according to the electric power transmission strategy, according to the monitoring and early warning signal, and send the monitoring and early warning result to the transmission platform, so that the transmission platform determines whether to adjust the electric power transmission strategy or not includes:
determining, by the early warning unit, thunderstorm weather starting and ending time points of the thunderstorm analysis area and preset starting and ending time points of the thunderstorm prediction time period, and predicated thunderstorm characteristic parameters and actual thunderstorm characteristic parameters of the thunderstorm analysis area according to the monitoring and early warning signal;
calculating, by the early warning unit, a time deviation of the thunderstorm weather starting and ending time points and the preset starting and ending time points, and a numerical value deviation of the predicated thunderstorm characteristic parameters and the actual thunderstorm characteristic parameters, comparing the time deviation with a preset time deviation threshold, and comparing the numerical value deviation with a preset numerical value deviation threshold.
when determining that the time deviation exceeds the time deviation threshold, or the numerical value deviation exceeds the numerical value deviation threshold, generating, by the early warning unit, a burst early warning signal and sending the burst early warning signal to the transmission platform, so that the transmission platform may adjust or pause the transmission task in the current transmission circuit and monitor the transmission device in real time during continuous transmission; and
when determining that the time deviation does not exceed the time deviation threshold, and the numerical value deviation does not exceed the numerical value deviation threshold, generating, by the early warning unit, a no-early-warning signal and sending the no-early-warning signal to the transmission platform.

It can be seen from the above technical solutions that the embodiments of the disclosure have the following advantages.

The disclosure provides an electric power transmission safety monitoring system for a thunderstorm area. The system includes a transmission platform, an area characteristic analysis unit and a transmission influence analysis unit. The transmission platform may receive an electric power transmission request sent by a current power supply end, determine a power demand end and a transmission area where the power demand end is located according to the electric power transmission request, and send an area characteristic analysis signal of the transmission area to the area characteristic analysis unit. After receiving the area characteristic analysis signal, the area characteristic analysis unit may carry out thunderstorm characteristic analysis on the transmission area according to the area characteristic analysis signal, and sends the thunderstorm characteristic analysis result to the transmission influence analysis unit and the transmission platform. After receiving the thunderstorm characteristic analysis result, the transmission platform may formulate an electric power transmission strategy of the transmission area according to the thunderstorm characteristic analysis result, and sends a transmission influence analysis signal to the transmission influence analysis unit in the process that electric power of the current power supply end is transmitted to the power demand end according to the electric power transmission strategy. After receiving the transmission influence analysis signal and the thunderstorm characteristic analysis result, the transmission influence analysis unit may carry out thunderstorm influence analysis on thunderstorm influence situation of real-time electric power transmission process of the transmission platform according to the transmission influence analysis signal and the thunderstorm characteristic analysis result, and send the thunderstorm influence analysis result to the transmission platform, so that the transmission platform determines whether to adjust the electric power transmission strategy or not. In the process, thunderstorm characteristic analysis is carried out on the transmission area corresponding to the transmission platform, so that electric power transmission is influenced by characteristics of the thunderstorm area is prevented, electric power transmission control is carried out through thunderstorm characteristic analysis, and the influence of thunderstorm characteristics on electric power transmission is reduced to the maximum extent. Thunderstorm influence analysis is carried out on the thunderstorm influence situation of the real-time electric power transmission process of the transmission platform, real-time monitoring and analysis are carried out on thunderstorm influence in the transmission process, the monitoring efficiency is improved, and the phenomena that the transmission process is influenced by thunderstorm, so that electric power transmission is abnormal, and meanwhile, thunderstorm influence is aggravated as that electric power transmission is influenced cannot be found in time are avoided.

### BRIEF DESCRIPTION OF DRAWINGS

In order to describe the technical solutions in the embodiments of the disclosure or in the relevant art more clearly, the drawings that need to be used in the description of the embodiments or the relevant art will be briefly introduced below. Apparently, the drawings in the description below are merely some embodiments of the disclosure, and those of ordinary skill in the art may also acquire other drawings according to these drawings without creative efforts.

FIG. 1 is a schematic structure diagram of an electric power transmission safety monitoring system for a thunderstorm area provided by embodiments of the disclosure.

FIG. 2 is a schematic structure diagram of another electric power transmission safety monitoring system for a thunderstorm area provided by embodiments of the disclosure.

### DETAILED DESCRIPTION OF THE EMBODIMENTS

The technical solutions in the embodiments of the disclosure will be described clearly and completely below in combination with the drawings in the embodiments of the disclosure. Apparently, the described embodiments are merely a part, rather than all embodiments, of the disclosure. On the basis of the embodiments in the disclosure, all other embodiments acquired by those of ordinary skill in the art without creative efforts fall within a protection scope of the disclosure.

In the relevant art, thunderstorm weather characteristic analysis cannot be carried out on a transmission area during electric power transmission, and then electric power transmission dispatching cannot be carried out according to area characteristics, so that the stability and safety of electric power transmission are influenced. Based thereon, the disclosure provides the following technical solution. Details can be referred to the text below.

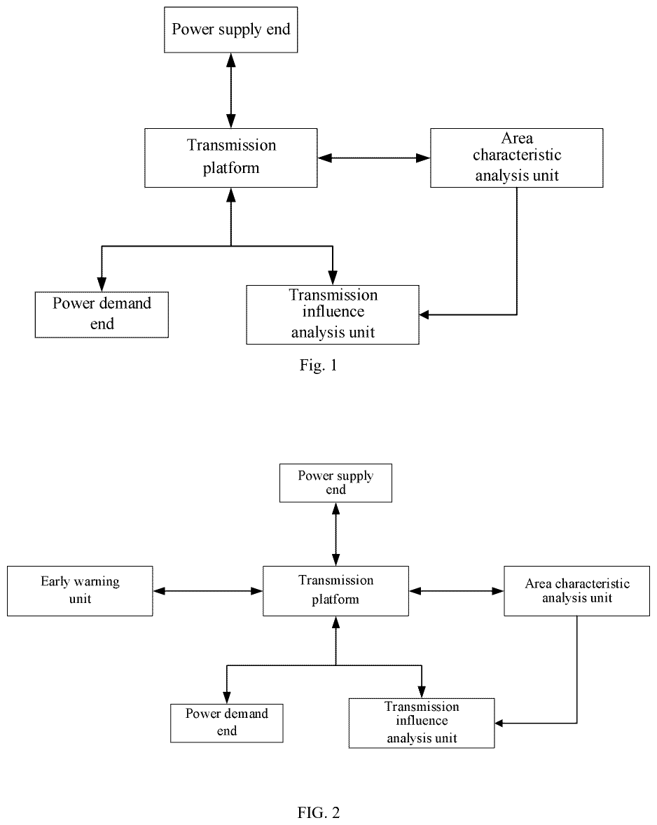

In an embodiment, as shown in FIG. 1, FIG. 1 is a schematic structure diagram of an electric power transmission safety monitoring system for a thunderstorm area provided by embodiments of the disclosure. The disclosure provides an electric power transmission safety monitoring system for a thunderstorm area. The system includes a transmission platform, an area characteristic analysis unit and a transmission influence analysis unit.

The transmission platform is configured to receive an electric power transmission request sent by a current power supply end, determine a power demand end and a transmission area where the power demand end is located according to the electric power transmission request, and then send an area characteristic analysis signal of the transmission area to the area characteristic analysis unit.

The area characteristic analysis unit is configured to receive the area characteristic analysis signal, carry out thunderstorm characteristic analysis on the transmission area according to the area characteristic analysis signal, and send the thunderstorm characteristic analysis result to the transmission influence analysis unit and the transmission platform.

The transmission platform is further configured to receive the thunderstorm characteristic analysis result, formulate an electric power transmission strategy of the transmission area according to the thunderstorm characteristic analysis result, and send a transmission influence analysis signal to the transmission influence analysis unit in the process that electric power of the current power supply end is transmitted to the power demand end according to the electric power transmission strategy.

The transmission influence analysis unit is configured to receive the transmission influence analysis signal and the thunderstorm characteristic analysis result, carry out thunderstorm influence analysis on real-time electric power transmission of the transmission platform according to the transmission influence analysis signal and the thunderstorm characteristic analysis result, and send the thunderstorm influence analysis result to the transmission platform, so that the transmission platform determines whether to adjust the electric power transmission strategy or not.

In the embodiment, the transmission platform may receive an electric power transmission request sent by a current power supply end when transmitting electric power transmitted by the power supply end, and determine a power demand end and a transmission area where the power demand end is located according to the electric power transmission request. It can be understood that the transmission platform may be connected with a plurality of power supply ends and power demand ends, so that when one power supply end sends an electric power transmission request to the transmission platform, the transmission platform may determine the current power demand end which is in urgent need of power transmission and the area where the power demand end is located according to the electric power transmission request, so that the power demand end and the transmission area corresponding to the power demand end may be obtained. Of course, in the disclosure, one power supply end may supply power to a plurality of power demand ends at the same time, or may supply power to one power demand end, when one power supply end supplies power to a plurality of power demand ends at the same time, a transmission area corresponding to each power demand end may be determined, and when one power supply end supplies power to one power demand end, only the transmission area corresponding to the power demand end needs to be determined.

After determining the power demand end and the corresponding transmission area, the transmission platform may send an area characteristic analysis signal related to the transmission area to the area characteristic analysis unit. After receiving the area characteristic analysis signal, the area characteristic analysis unit may carry out thunderstorm characteristic analysis on the transmission area according to the area characteristic analysis signal, and send the thunderstorm characteristic analysis result to the transmission influence analysis unit and the transmission unit. After receiving the thunderstorm characteristic analysis result, the transmission unit may formulate an electric power transmission strategy of the transmission area according to the thunderstorm characteristic analysis result, and transmit electric power of the current power supply end to the power demand end according to the electric power transmission strategy. In the process, the transmission platform may further send a transmission influence analysis signal to the transmission influence analysis unit. After receiving the transmission influence analysis signal, the transmission influence analysis unit may carry out thunderstorm influence analysis on thunderstorm influence situation of real-time electric power transmission process of the transmission platform according to the transmission influence analysis signal and the thunderstorm characteristic analysis result, and send the thunderstorm influence analysis result to the transmission platform, so that the transmission platform determines whether to adjust the electric power transmission strategy or not.

For example, when the transmission influence analysis unit carries out thunderstorm influence analysis on thunderstorm influence situation of real-time electric power transmission process of the transmission platform according to the thunderstorm characteristic analysis result, if the analysis result indicates that the current power transmission line may not be influenced by thunderstorm, the electric power transmission strategy does not need to be adjusted, if the analysis result indicates that the current power transmission line may be influenced by thunderstorm, the electric power transmission strategy may be adjusted, for example, power transmission amount of the time period influenced by thunderstorm is adjusted, or transmission time is adjusted, and limitation is not made herein.

In the above embodiment, the system includes a transmission platform, an area characteristic analysis unit and a transmission influence analysis unit. The transmission platform may receive an electric power transmission request sent by a current power supply end, determine a power demand end and a transmission area where the power demand end is located according to the electric power transmission request, and send an area characteristic analysis signal of the transmission area to the area characteristic analysis unit. After receiving the area characteristic analysis signal, the area characteristic analysis unit may carry out thunderstorm characteristic analysis on the transmission area according to the area characteristic analysis signal, and sends the thunderstorm characteristic analysis result to the transmission influence analysis unit and the transmission platform. After receiving the thunderstorm characteristic analysis result, the transmission platform may formulate an electric power transmission strategy of the transmission area according to the thunderstorm characteristic analysis result, and sends a transmission influence analysis signal to the transmission influence analysis unit in the process that electric power of the current power supply end is transmitted to the power demand end according to the electric power transmission strategy. After receiving the transmission influence analysis signal and the thunderstorm characteristic analysis result, the transmission influence analysis unit may carry out thunderstorm influence analysis on thunderstorm influence situation of real-time electric power transmission process of the transmission platform according to the transmission influence analysis signal and the thunderstorm characteristic analysis result, and send the thunderstorm influence analysis result to the transmission platform, so that the transmission platform determines whether to adjust the electric power transmission strategy or not. In the process, thunderstorm characteristic analysis is carried out on the transmission area corresponding to the transmission platform, so that electric power transmission is influenced by characteristics of the thunderstorm area is prevented, electric power transmission control is carried out through thunderstorm characteristic analysis, and the influence of thunderstorm characteristics on electric power transmission is reduced to the maximum extent. Thunderstorm influence analysis is carried out on the thunderstorm influence situation of the real-time electric power transmission process of the transmission platform, real-time monitoring and analysis are carried out on thunderstorm influence in the transmission process, the monitoring efficiency is improved, and the phenomena that the transmission process is influenced by thunderstorm, so that electric power transmission is abnormal, and meanwhile, thunderstorm influence is aggravated as that electric power transmission is influenced cannot be found in time are avoided.

In an embodiment, the process that the area characteristic analysis unit carries out thunderstorm characteristic analysis on the transmission area according to the area characteristic analysis signal to obtain a thunderstorm characteristic analysis result may includes:

The area characteristic analysis unit determines an area in which thunderstorm exists in the transmission area according to the area characteristic analysis signal, and after marking the area in which thunderstorm exists as a thunderstorm analysis area, acquires instantaneous increase amount corresponding to cloud-to-ground lightning frequency of the thunderstorm in the thunderstorm analysis area, average probability of lightning current amplitude of each area in the thunderstorm analysis area, and average duration period of thunderstorm weather occurring in the thunderstorm analysis area.
generating, by the area characteristic analysis unit, a thunderstorm characteristic analysis coefficient in the thunderstorm analysis area according to the instantaneous increase amount, average probability of lightning current amplitude of each area and average duration period of thunderstorm weather occurring in the thunderstorm analysis area, and determining a thunderstorm characteristic analysis result of the thunderstorm analysis area according to the thunderstorm characteristic analysis coefficient.

In the embodiment, when carrying out thunderstorm characteristic analysis on the transmission area according to the area characteristic analysis signal, the area characteristic analysis unit may first determine the area in which thunderstorm exists in the transmission area according to the area characteristic analysis signal, marks it as a thunderstorm analysis area, then acquires instantaneous increase amount corresponding to cloud-to-ground lightning frequency of the thunderstorm in the thunderstorm analysis area, average probability of lightning current amplitude of each area in the thunderstorm analysis area, and average duration period of thunderstorm weather occurring in the thunderstorm analysis area through meteorological data of a meteorological station and the like, then a thunderstorm characteristic analysis coefficient in the thunderstorm analysis area may be generated according to the acquired related data, and the thunderstorm characteristic analysis result of the thunderstorm analysis area is determined according to the thunderstorm characteristic analysis coefficient.

It can be understood that, in the disclosure, when the area in which thunderstorm exists in the transmission area is determined, one area may exist or a plurality of areas may exist, therefore, the number of the thunderstorm analysis area of the disclosure may be one or more, when a plurality of thunderstorm analysis areas exist, the thunderstorm characteristic analysis result aiming at each thunderstorm analysis area may be carried out according to the above analysis process, and no elaboration will be made here.

In the above embodiment, when the thunderstorm characteristics in the transmission area are analyzed, first, the thunderstorm analysis area in the transmission area is determined according to the area characteristic analysis signal, then instantaneous increase amount corresponding to cloud-to-ground lightning frequency of the thunderstorm in the thunderstorm analysis area, average probability of lightning current amplitude of each area in the thunderstorm analysis area, and average duration period of thunderstorm weather occurring in the thunderstorm analysis area are acquired through meteorological data of a meteorological station and the like, then the generated thunderstorm characteristic analysis coefficient in the thunderstorm analysis area may be more accurate, and thus the accuracy of the thunderstorm characteristic analysis result of the thunderstorm analysis area is effectively improved.

In an embodiment, when the area characteristic analysis unit generates a thunderstorm characteristic analysis coefficient in the thunderstorm analysis area according to the instantaneous increase amount, average probability of lightning current amplitude of each area and average duration period of thunderstorm weather occurring in the thunderstorm analysis area, a calculation formula is:

$$G = DS \times v 1 + GL \times v 2 + CZ \times v 3$$

In the formula, G is the thunderstorm characteristic analysis coefficient in the thunderstorm analysis area, DS is instantaneous increase amount corresponding to cloud-to-ground lightning frequency of the thunderstorm in the thunderstorm analysis area, GL is average probability of lightning current amplitude of each area in the thunderstorm analysis area, CZ is average duration period of thunderstorm weather occurring in the thunderstorm analysis area, v1, v2 and v3 are preset proportional coefficients, and v1>v2>v3>0.

It can be understood that the above formulas are all obtained by collecting a large amount of data, performing software simulation, and selecting one formula close to the true value, and the coefficient in the formula may be set by the skilled in the art according to actual conditions, which is not limited herein.

In the above embodiment, the thunderstorm characteristic analysis coefficient may be rapidly calculated through the calculation formula of the thunderstorm characteristic analysis coefficient in the thunderstorm analysis area, and thus the calculation efficiency of the thunderstorm characteristic analysis result is effectively improved.

In an embodiment, the process that the area characteristic analysis unit determines a thunderstorm characteristic analysis result of the thunderstorm analysis area according to the thunderstorm characteristic analysis coefficient may include:
the area characteristic analysis unit compares the thunderstorm characteristic analysis coefficient with a preset thunderstorm characteristic analysis coefficient threshold.

When determining the thunderstorm characteristic analysis coefficient exceeds the thunderstorm characteristic analysis coefficient threshold, the area characteristic analysis unit judges the thunderstorm characteristic in the thunderstorm analysis area as high influence characteristics.
when determining the thunderstorm characteristic analysis coefficient does not exceed the thunderstorm characteristic analysis coefficient threshold, judging, by the area characteristic analysis unit, the thunderstorm characteristics in the thunderstorm analysis area as low influence characteristics.

In the embodiment, when determining the thunderstorm characteristic analysis result of the thunderstorm analysis area according to the thunderstorm characteristic analysis coefficient, the area characteristic analysis unit may first compare the thunderstorm characteristic analysis coefficient with a preset thunderstorm characteristic analysis coefficient threshold, when the thunderstorm characteristic analysis coefficient exceeds the thunderstorm characteristic analysis coefficient threshold, the thunderstorm characteristics in the thunderstorm analysis area are judged as high influence characteristics, when the thunderstorm characteristic analysis coefficient does not exceed the thunderstorm characteristic analysis coefficient threshold, the thunderstorm characteristics in the thunderstorm analysis area are judged as low influence characteristics, and then the thunderstorm characteristic analysis result of the thunderstorm analysis area may be determined.

In the above embodiment, after comparing the thunderstorm characteristic analysis coefficient with the thunderstorm characteristic analysis coefficient threshold, whether the thunderstorm characteristics in the thunderstorm analysis area are high influence characteristics or low influence characteristics may be rapidly determined, and thus the analysis efficiency is effectively improved.

In an embodiment, the thunderstorm characteristic analysis result includes a thunderstorm analysis area with high influence characteristics and a thunderstorm analysis area with low influence characteristics, and the thunderstorm analysis area is an area in which thunderstorm exists in the transmission area.

The process that the transmission platform formulates an electric power transmission strategy of the transmission area according to the thunderstorm characteristic analysis result includes:
When determining the thunderstorm characteristic analysis result as the thunderstorm analysis area with high influence characteristics, the transmission platform carries out thunderstorm predication on the thunderstorm analysis area with high influence characteristics, and after a thunderstorm predication time period is determined according to the thunderstorm predication result, electric power transmission amount in the thunderstorm predication time period is reduced to a minimum value.
when the thunderstorm characteristic analysis result is determined as the thunderstorm analysis area with low influence characteristics, determining, by the transmission platform, whether electric power transmission amount, in the thunderstorm predication time period, of the thunderstorm analysis area with high influence characteristics in the transmission area is reduced to a minimum value or not, and when the electric power transmission amount cannot be reduced to the minimum value, temporarily switching an electric power transmission line of the thunderstorm analysis area with high influence characteristics to the thunderstorm analysis area with low influence characteristics.

In the embodiment, if the thunderstorm characteristic analysis coefficient in the thunderstorm analysis area exceeds the thunderstorm characteristic analysis coefficient threshold, thunderstorm characteristics in the thunderstorm analysis area are judged as high influence characteristics, a high influence signal is generated and sent to the transmission platform, the transmission platform will carry out thunderstorm predication on the thunderstorm analysis area in the electric power transmission process after receiving the high influence signal and the corresponding thunderstorm analysis area, after a predication time period is acquired, electric power transmission amount in the predication time period is reduced to the minimum by adjusting transmission schedule, and the phenomenon that the thunderstorm analysis area is influenced by thunderstorm weather, consequently, the safety of electric power transmission is reduced, and the schedule of electric power transmission is directly hindered is avoided.

If the thunderstorm characteristic analysis coefficient in the thunderstorm analysis area does not exceed the thunderstorm characteristic analysis coefficient threshold, thunderstorm characteristics in the thunderstorm analysis area are judged as low influence characteristics, a low influence signal is generated and sent to the transmission platform, after receiving the low influence signal and the corresponding thunderstorm analysis area, when the transmission schedule adjustment cannot reduce the electric power transmission amount in the thunderstorm analysis area with high influences to the minimum, the transmission platform may temporarily switch the current electric power transmission line, the current thunderstorm analysis area with low influence characteristics is taken as a switching area serving as a temporary passage area for execution of the current task, so that influences of thunderstorm weather on the thunderstorm analysis area with high influence characteristics are reduced.

In an embodiment, the thunderstorm characteristic analysis result includes a thunderstorm analysis area in which thunderstorm exists in the transmission area.

The process that the transmission influence analysis unit carries out thunderstorm influence analysis on thunderstorm influence situation of real-time electric power transmission process of the transmission platform according to the transmission influence analysis signal and the thunderstorm characteristic analysis result to obtain the thunderstorm influence analysis result may include:
determining, by the transmission influence analysis unit, tripping frequency of a switching device in the thunderstorm analysis area during the real-time power transmission process and continuous increase span of starting height of the cloud-to-ground lightning in the thunderstorm analysis area according to the transmission influence analysis signal and the thunderstorm characteristic analysis result, and determining an electric power transmission influence result influenced by thunderstorm of the real-time electric power transmission process in the thunderstorm analysis area according to the tripping frequency of the switching device and the continuous increase span of starting height of the cloud-to-ground lightning.

In the embodiment, when carrying out thunderstorm influence analysis on thunderstorm influence situation of real-time electric power transmission process of the transmission platform, the transmission influence analysis unit may first determine tripping frequency of a switching device in the thunderstorm analysis area during the real-time power transmission process and continuous increase span of starting height of the cloud-to-ground lightning in the thunderstorm analysis area according to the transmission influence analysis signal and the thunderstorm characteristic analysis result, then the electric power transmission influence result influenced by thunderstorm of the real-time electric power transmission process in the thunderstorm analysis area may be determined according to the tripping frequency of the switching device and the continuous increase span of starting height of the cloud-to-ground lightning, so that the analysis accuracy and analysis efficiency of the electric power transmission influence result are effectively improved.

In an embodiment, the process that the transmission influence analysis unit determines the electric power transmission influence result influenced by thunderstorm, of the real-time electric power transmission process in the thunderstorm analysis area according to tripping frequency of the switching device and the continuous increase span of starting height of the cloud-to-ground lightning may include:
the transmission influence analysis unit compares the tripping frequency of the switching device with a preset tripping frequency threshold, and compares continuous increase span of starting height of the cloud-to-ground lightning with a preset a height increase span threshold.

When determining that the tripping frequency of the switching device exceeds a tripping frequency threshold or the continuous increase span of starting height of the cloud-to-ground lightning exceeds a height increase span threshold, the transmission influence analysis unit judges that the electric power transmission process influence result influenced by thunderstorm of real-time electric power transmission in the thunderstorm analysis area is influenced.

When determining that the tripping frequency of the switching device does not exceed a tripping frequency threshold and the continuous increase span of starting height of the cloud-to-ground lightning does not exceed a height increase span threshold, the transmission influence analysis unit judges that the electric power transmission process influence result influenced by thunderstorm of real-time electric power transmission in the thunderstorm analysis area is not influenced.

In the embodiment, when determining the electric power transmission influence result influenced by thunderstorm of real-time electric power transmission in the thunderstorm analysis area, the transmission influence analysis unit may compare the tripping frequency of the switching device with a preset tripping frequency threshold and compare the continuous increase span of starting height of the cloud-to-ground lightning with a preset height increase span threshold, if the tripping frequency of the switching device exceeds the tripping frequency threshold and the continuous increase span of starting height of the cloud-to-ground lightning exceeds the height increase span threshold, it is judged that the electric power transmission process influence result influenced by thunderstorm of the real-time electric power transmission in the thunderstorm analysis area is influenced, if the tripping frequency of the switching device does not exceed the tripping frequency threshold and the continuous increase span of starting height of the cloud-to-ground lightning does not exceed the height increase span threshold, it is judged that the electric power transmission influence result influenced by thunderstorm of the real-time electric power transmission process in the thunderstorm analysis area is not influenced. In the process, by comparing the tripping frequency of the switching device with the tripping frequency threshold and comparing the continuous increase span of starting height of the cloud-to-ground lightning with the height increase span threshold, whether the real-time electric power transmission process in the thunderstorm analysis area is influenced by thunderstorm or not may be rapidly judged.

In an embodiment, the thunderstorm influence analysis result includes that the real-time electric power transmission process in the thunderstorm analysis area is influenced by thunderstorm and not influenced by thunderstorm, and the thunderstorm analysis area is an area in which thunderstorm exists in the transmission area.

The process that the transmission platform determines whether to adjust the electric power transmission strategy or not according to the thunderstorm influence analysis result may include:
when determining that the real-time electric power transmission process in the thunderstorm analysis area is influenced by thunderstorm, the transmission platform adjusts electric power transmission amount and transmission time related to the thunderstorm analysis area in the electric power transmission strategy.
when determining, by the transmission platform, that the real-time electric power transmission process in the thunderstorm analysis area is not influenced by thunderstorm, the electric power transmission strategy does not need to be adjusted.

In the embodiment, if the tripping frequency of the switching device in the thunderstorm analysis area exceeds the tripping frequency threshold or the continuous increase span of starting height of the cloud-to-ground lightning in the thunderstorm analysis area exceeds the height increase span threshold in the electric power transmission process, it is judged that the electric power transmission process in the current thunderstorm analysis area is influenced, an electric power transmission influence signal is generated and the electric power transmission influence signal is sent to the transmission platform, and the transmission platform carries out transmission amount adjustment and transmission time adjustment on the transmission task of the corresponding thunderstorm analysis area.

If the tripping frequency of the switching device in the thunderstorm analysis area does not exceed the tripping frequency threshold and the continuous increase span of starting height of the cloud-to-ground lightning in the thunderstorm analysis area does not exceed the height increase span threshold in the electric power transmission process, it is judged that the electric power transmission process in the current thunderstorm analysis area is not influenced, an electric power transmission safety signal is generated, and the electric power transmission safety signal is sent to the transmission platform.

In the embodiment, by comparing the tripping frequency of the switching device with the tripping frequency threshold, and comparing the continuous increase span of starting height of the cloud-to-ground lightning in the thunderstorm analysis area with the height increase span threshold, whether the real-time electric power transmission process in the thunderstorm analysis area is influenced by thunderstorm or not may be rapidly determined, the electric power transmission strategy is adjusted when it is influenced by thunderstorm, so that potential safety hazards caused by influence of thunderstorm are effectively reduced, and the safety of electric power transmission is improved.

In an embodiment, as shown in FIG. 2, FIG. 2 is a schematic structure diagram of another electric power transmission safety monitoring system for a thunderstorm area provided by embodiments of the disclosure. The system may further includes an early warning unit.

The transmission platform is further configured to send a monitoring and early warning signal related to the electric power transmission strategy to the early warning unit after receiving a transmission influence analysis completion instruction sent by the transmission influence analysis unit.

The early warning unit is configured to receive the monitoring and early warning signal, and carry out safety monitoring and early warning on the process that the transmission platform carries out real-time electric power transmission on the power demand end according to the electric power transmission strategy, according to the monitoring and early warning signal, and send the monitoring and early warning result to the transmission platform, so that the transmission platform determines whether to adjust the electric power transmission strategy or not.

In the embodiment, after receiving the transmission influence analysis completion instruction sent by the transmission influence analysis unit, the transmission platform may generate a monitoring and early warning signal according to a pre-configured monitoring and early warning signal generation method and send the monitoring and early warning signal to the early warning unit. After receiving the monitoring and early warning signal, the early warning unit carries out monitoring and early warning on the thunderstorm analysis area in the electric power transmission process, so the phenomenon that a deviation exists between real-time characteristics and predicated characteristics of the thunderstorm analysis area in the transmission process, consequently, a safety problem exists in electric power transmission of the thunderstorm analysis area, and the qualification of the electric power transmission is influenced is avoided.

Specifically, the early warning unit may carry out safety monitoring and early warning on the process that the transmission platform carries out real-time electric power transmission on the power demand end according to the electric power transmission strategy, according to the monitoring and early warning signal, and send the monitoring and early warning result to the transmission platform, so that the transmission platform determines whether to adjust the electric power transmission strategy or not, and the safety and stability of electric power transmission are improved.

In an embodiment, the electric power transmission strategy includes that electric power transmission amount, in the thunderstorm predication time period, of the thunderstorm analysis area with high influence characteristics is reduced to a minimum value, and the thunderstorm analysis area is an area in which thunderstorm exists in the transmission area.

The process that the early warning unit carries out safety monitoring and early warning on the process that the transmission platform carries out real-time electric power transmission on the power demand end according to the electric power transmission strategy, according to the monitoring and early warning signal, and sends the monitoring and early warning result to the transmission platform, so that the transmission platform determines whether to adjust the electric power transmission strategy or not may include:
the early warning unit determines thunderstorm weather starting and ending time points of the thunderstorm analysis area and preset starting and ending time points of the thunderstorm prediction time period, and predicated thunderstorm characteristic parameters and actual thunderstorm characteristic parameters of the thunderstorm analysis area according to the monitoring and early warning signal.

The early warning unit calculates a time deviation of the thunderstorm weather starting and ending time points and the preset starting and ending time points, or a numerical value deviation of the predicated thunderstorm characteristic parameters and the actual thunderstorm characteristic parameters, compares the time deviation with a preset time deviation threshold, and compares the numerical value deviation with a preset numerical value deviation threshold.

When determining that the time deviation exceeds the time deviation threshold, or the numerical value deviation exceeds the numerical value deviation threshold, the early warning unit generates a burst early warning signal and sends the burst early warning signal to the transmission platform, so that the transmission platform may adjust or pause the transmission task in the current transmission circuit and monitor the transmission device in real time during continuous transmission.
when determining that the time deviation does not exceed the time deviation threshold, and the numerical value deviation does not exceed the numerical value deviation threshold, generating, by the early warning unit, a no-early-warning signal and sending the no-early-warning signal to the transmission platform.

In the embodiment, after acquiring the deviation of thunderstorm weather starting and ending time points and the preset starting and ending time points in the thunderstorm analysis area and the numerical value deviation of the predicated thunderstorm characteristic parameters and the actual thunderstorm characteristic parameters of thunderstorm weather in the thunderstorm analysis area, the early warning unit may respectively compare the deviation of the thunderstorm weather starting and ending time points and the preset starting and ending time points with the time deviation threshold and compare the numerical value deviation of the predicated thunderstorm characteristic parameters and the actual thunderstorm characteristic parameters of thunderstorm weather in the thunderstorm analysis area with the numerical value deviation threshold. The thunderstorm characteristic parameters are expressed as parameters of the thunderstorm weather in the thunderstorm analysis area, such as parameters of thunderstorm time-space variation, cloud-to-ground lightning density, lightning current amplitude and the like.

If the deviation of thunderstorm weather starting and ending time points and preset starting and ending time points in the thunderstorm analysis area exceeds the time deviation threshold or the numerical value deviation of the predicated thunderstorm characteristic parameters and the actual thunderstorm characteristic parameters of thunderstorm weather in the thunderstorm analysis area exceeds the numerical value deviation threshold, early warning is carried out on electric power transmission of the thunderstorm analysis area, a burst early warning signal is generated and sent to the transmission platform, so that after receiving the burst early warning signal, the transmission platform adjusts or pauses the transmission task in the current transmission circuit and monitors the transmission device in real time during continuous transmission.

If the deviation of the thunderstorm weather starting and ending time points and the preset starting and ending time points in the thunderstorm analysis area does not exceeds the time deviation threshold or the numerical value deviation of the predicated thunderstorm characteristic parameters and the actual thunderstorm characteristic parameters of thunderstorm weather in the thunderstorm analysis area does not exceed the numerical value deviation threshold, no early warning is carried out on electric power transmission of the thunderstorm analysis area, and a no-early-warning signal is generated, and the no-early-warning signal is sent to the transmission platform.

In the above embodiment, the early warning unit may determine whether to generate a burst early warning signal or a no-early-warning signal according to that whether the deviation of the thunderstorm weather starting and ending time points and the preset starting and ending time points in the thunderstorm analysis area exceeds the time deviation threshold or not, or whether the numerical value deviation of the predicated thunderstorm characteristic parameters and the actual thunderstorm characteristic parameters of thunderstorm weather in the thunderstorm analysis area exceeds the numerical value deviation threshold not, so that an accurate early warning signal is given.

Finally, it is to be noted that in the specification, relational terms such as “first” and “second” are used merely to distinguish one entity or operation from another entity or operation without necessarily requiring or implying any actual such relationship or order between such entities or operations. Furthermore, the terms “include”, “comprise”, or any variants thereof are intended to cover a non-exclusive inclusion, so that a process, method, article, or equipment that includes a series of elements not only includes those elements, but also includes other elements not listed explicitly, or includes inherent elements of the process, method, article, or equipment. An element defined by the statement “comprises a . . . ” does not, without more constraints, preclude the existence of additional identical elements in the process, method, article, or equipment that comprises the element.

The embodiments in the specification are described in a progressive manner, each embodiment is focused on differing from the other embodiments, the embodiments may be combined as needed, and the same and similar parts of the embodiments are referred to with respect to each other.

The previous description of the disclosed embodiments enables the skilled in the art to implement or use the disclosure. Various modifications to these embodiments will be readily apparent to the skilled in the art, and the generic principles defined herein may be implemented in other embodiments without departing from the spirit or scope of the disclosure. Thus, the disclosure is not to be limited to these embodiments shown herein but is to be accorded the widest scope consistent with the principles and novel features disclosed herein.

What is claimed is:

1. An electric power transmission safety monitoring system for a thunderstorm area, wherein the system comprises a transmission platform, an area characteristic analysis unit and a transmission influence analysis unit;
the transmission platform is configured to receive an electric power transmission request sent by a current power supply end, determine a power demand end and a transmission area where the power demand end is located according to the electric power transmission request, and then send an area characteristic analysis signal of the transmission area to the area characteristic analysis unit;
the area characteristic analysis unit is configured to receive the area characteristic analysis signal, carry out thunderstorm characteristic analysis on the transmission area according to the area characteristic analysis signal, and send the thunderstorm characteristic analysis result to the transmission influence analysis unit and the transmission platform;
the transmission platform is further configured to receive the thunderstorm characteristic analysis result, formulate an electric power transmission strategy of the transmission area according to the thunderstorm characteristic analysis result, and send a transmission influence analysis signal to the transmission influence analysis unit in the process that electric power of the current power supply end is transmitted to the power demand end according to the electric power transmission strategy;
the transmission influence analysis unit is configured to receive the transmission influence analysis signal and the thunderstorm characteristic analysis result, carry out thunderstorm influence analysis on thunderstorm influence situation of the real-time electric power transmission process of the transmission platform according to the transmission influence analysis signal and the thunderstorm characteristic analysis result, and send the thunderstorm influence analysis result to the transmission platform, so that the transmission platform determines whether to adjust the electric power transmission strategy or not.

2. The electric power transmission safety monitoring system for a thunderstorm area according to claim 1, wherein the process that the area characteristic analysis unit carries out thunderstorm characteristic analysis on the transmission area according to the area characteristic analysis signal to obtain a thunderstorm characteristic analysis result comprises:
determining, by the area characteristic analysis unit, an area in which thunderstorm exists in the transmission area according to the area characteristic analysis signal, and after marking the area in which thunderstorm exists as a thunderstorm analysis area, acquiring instantaneous increase amount corresponding to cloud-to-ground lightning frequency of the thunderstorm in the thunderstorm analysis area, average probability of lightning current amplitude of each area in the thunderstorm analysis area, and average duration period of thunderstorm weather occurring in the thunderstorm analysis area; and
generating, by the area characteristic analysis unit, a thunderstorm characteristic analysis coefficient in the thunderstorm analysis area according to the instantaneous increase amount, the average probability of lightning current amplitude of each area and the average duration period of thunderstorm weather occurring in the thunderstorm analysis area, and determining a thunderstorm characteristic analysis result of the thunderstorm analysis area according to the thunderstorm characteristic analysis coefficient.

3. The electric power transmission safety monitoring system for a thunderstorm area according to claim 2, wherein in generating, by the area characteristic analysis unit, a thunderstorm characteristic analysis coefficient in the thunderstorm analysis area according to the instantaneous increase amount, average probability of lightning current amplitude of each area and average duration period of thunderstorm weather occurring in the thunderstorm analysis area, a calculation formula is:
$$G = DS \times v 1 + GL \times v 2 + CZ \times v 3$$
in the formula, G is the thunderstorm characteristic analysis coefficient in the thunderstorm analysis area, DS is instantaneous increase amount corresponding to cloud-to-ground lightning frequency of the thunderstorm in the thunderstorm analysis area, GL is average probability of lightning current amplitude of each area in the thunderstorm analysis area, CZ is average duration period of thunderstorm weather occurring in the thunderstorm analysis area, v1, v2 and v3 are preset proportional coefficients, and v1>v2>v3>0.

4. The electric power transmission safety monitoring system for a thunderstorm area according to claim 2, wherein the process that determining, by the area characteristic analysis unit, a thunderstorm characteristic analysis result of the thunderstorm analysis area according to the thunderstorm characteristic analysis coefficient comprises:
comparing, by the area characteristic analysis unit, the thunderstorm characteristic analysis coefficient with a preset thunderstorm characteristic analysis coefficient threshold;
when determining the thunderstorm characteristic analysis coefficient exceeds the thunderstorm characteristic analysis coefficient threshold, judging, by the area characteristic analysis unit, the thunderstorm characteristics in the thunderstorm analysis area as high influence characteristics; and
when determining the thunderstorm characteristic analysis coefficient does not exceed the thunderstorm characteristic analysis coefficient threshold, judging, by the area characteristic analysis unit, the thunderstorm characteristics in the thunderstorm analysis area as low influence characteristics.

5. The electric power transmission safety monitoring system for a thunderstorm area according to claim 1, wherein the thunderstorm characteristic analysis result comprises a thunderstorm analysis area with high influence characteristics and a thunderstorm analysis area with low influence characteristics, and the thunderstorm analysis area is an area in which thunderstorm exists in the transmission area;
the process that the transmission platform formulates an electric power transmission strategy of the transmission area according to the thunderstorm characteristic analysis result comprises:
when the thunderstorm characteristic analysis result is determined as the thunderstorm analysis area with high influence characteristics, carrying out thunderstorm predication, by the transmission platform, on the thunderstorm analysis area with high influence characteristics, and after determining a thunderstorm predication time period according to the thunderstorm predication result, reducing electric power transmission amount in the thunderstorm predication time period to a minimum value; and
when the thunderstorm characteristic analysis result is determined as the thunderstorm analysis area with low influence characteristics, determining, by the transmission platform, whether electric power transmission amount, in the thunderstorm predication time period, of the thunderstorm analysis area with high influence characteristics in the transmission area is reduced to a minimum value or not, and when the electric power transmission amount cannot be reduced to the minimum value, temporarily switching an electric power transmission line of the thunderstorm analysis area with high influence characteristics to the thunderstorm analysis area with low influence characteristics.

6. The electric power transmission safety monitoring system for a thunderstorm area according to claim 1, wherein the thunderstorm characteristic analysis result comprises a thunderstorm analysis area in which thunderstorm exists in the transmission area;
the process that, carrying out thunderstorm influence analysis, by the transmission influence analysis unit, on thunderstorm influence situation of real-time electric power transmission process of the transmission platform according to the transmission influence analysis signal and the thunderstorm characteristic analysis result to obtain a thunderstorm influence analysis result comprises:
determining, by the transmission influence analysis unit, tripping frequency of a switching device in the thunderstorm analysis area during the real-time power transmission process and continuous increase span of starting height of the cloud-to-ground lightning in the thunderstorm analysis area according to the transmission influence analysis signal and the thunderstorm characteristic analysis result, and determining an electric power transmission influence result influenced by thunderstorm of the real-time electric power transmission process in the thunderstorm analysis area according to the tripping frequency of the switching device and the continuous increase span of starting height of the cloud-to-ground lightning.

7. The electric power transmission safety monitoring system for a thunderstorm area according to claim 6, wherein the process that determining, by the transmission influence analysis unit, the electric power transmission influence result influenced by thunderstorm of the real-time electric power transmission process in the thunderstorm analysis area according to tripping frequency of the switching device and the continuous increase span of starting height of the cloud-to-ground lightning comprises:
comparing, by the transmission influence analysis unit, the tripping frequency of the switching device with a preset tripping frequency threshold, and comparing continuous increase span of starting height of the cloud-to-ground lightning with a preset a height increase span threshold;
when the tripping frequency of the switching device is determined to exceed a tripping frequency threshold or the continuous increase span of starting height of the cloud-to-ground lightning is determined to exceed a height increase span threshold, judging, by the transmission influence analysis unit, that the electric power transmission influence result influenced by thunderstorm of the real-time electric power transmission process in the thunderstorm analysis area as being influenced; and
when the tripping frequency of the switching device is determined to not exceed a tripping frequency threshold and the continuous increase span of starting height of the cloud-to-ground lightning is determined to not exceed a height increase span threshold, determining, by the transmission influence analysis unit, that the electric power transmission influence result influenced by thunderstorm of the real-time electric power transmission process in the thunderstorm analysis area as not being influenced.

8. The electric power transmission safety monitoring system for a thunderstorm area according to claim 1, wherein the thunderstorm influence analysis result comprises that real-time electric power transmission in the thunderstorm analysis area is influenced by thunderstorm and not influenced by thunderstorm, and the thunderstorm analysis area is an area in which thunderstorm exists in the transmission area;
the process that the transmission platform determines whether to adjust the electric power transmission strategy or not according to the thunderstorm influence analysis result comprises:
when determining that the real-time electric power transmission process in the thunderstorm analysis area is influenced by thunderstorm, adjusting, by the transmission platform, electric power transmission amount and transmission time related to the thunderstorm analysis area in the electric power transmission strategy; and
when determining, by the transmission platform, that the real-time electric power transmission process in the thunderstorm analysis area is not influenced by thunderstorm, the electric power transmission strategy does not need to be adjusted.

9. The electric power transmission safety monitoring system for a thunderstorm area according to claim 8, wherein the system further comprises an early warning unit;
the transmission platform is further configured to send a monitoring and early warning signal related to the electric power transmission strategy to the early warning unit after receiving a transmission influence analysis completion instruction sent by the transmission influence analysis unit; and
the early warning unit is configured to receive the monitoring and early warning signal, and carry out safety monitoring and early warning on the process that the transmission platform carries out real-time electric power transmission on the power demand end according to the electric power transmission strategy, according to the monitoring and early warning signal, and send the monitoring and early warning result to the transmission platform, so that the transmission platform determines whether to adjust the electric power transmission strategy or not.

10. The electric power transmission safety monitoring system for a thunderstorm area according to claim 9, wherein the electric power transmission strategy comprises that electric power transmission amount, in the thunderstorm predication time period, of the thunderstorm analysis area with high influence characteristics is reduced to a minimum value, and the thunderstorm analysis area is an area in which thunderstorm exists in the transmission area;
the process that the early warning unit carries out safety monitoring and early warning on the process that the transmission platform carries out real-time electric power transmission on in the power demand end according to the electric power transmission strategy, according to the monitoring and early warning signal, and sends the monitoring and early warning result to the transmission platform, so that the transmission platform determines whether to adjust the electric power transmission strategy or not comprises:
determining, by the early warning unit, thunderstorm weather starting and ending time points of the thunderstorm analysis area and preset starting and ending time points of the thunderstorm prediction time period, and predicated thunderstorm characteristic parameters and actual thunderstorm characteristic parameters of the thunderstorm analysis area according to the monitoring and early warning signal;
calculating, by the early warning unit, a time deviation of the thunderstorm weather starting and ending time points and the preset starting and ending time points, and a numerical value deviation of the predicated thunderstorm characteristic parameters and the actual thunderstorm characteristic parameters, comparing the time deviation with a preset time deviation threshold, and comparing the numerical value deviation with a preset numerical value deviation threshold;
when determining that the time deviation exceeds the time deviation threshold, or the numerical value deviation exceeds the numerical value deviation threshold, generating, by the early warning unit, a burst early warning signal and sending the burst early warning signal to the transmission platform, so that the transmission platform adjusts or pause the transmission task in the current transmission circuit and monitor the transmission device in real time during continuous transmission; and
when determining that the time deviation does not exceed the time deviation threshold, and the numerical value deviation does not exceed the numerical value deviation threshold, generating, by the early warning unit, a no-early-warning signal and sending the no-early-warning signal to the transmission platform.
